(19) United States
(12) Patent Application Publication
(10) Pub. No.: US 2026/0243162 A1
(43) Pub. Date: Aug. 20, 2026

(54) PULSED MAGNETIC FIELD TELEMETRY TO COMMUNICATE WITH A DOWNHOLE INFLOW VALVE

(71) Applicant: Halliburton Energy Services, Inc., Houston, TX (US)

(72) Inventors: Ryan W. McChesney, Prosper, TX (US); Gordon McLeary, Frisco, TX (US); Stephen Michael Greci, Little Elm, TX (US)

(21) Appl. No.: 19/057,682

(22) Filed: Feb. 19, 2025

(51) Int. Cl. E21B 47/135; E21B 34/16; G08C 23/02

(52) U.S. Cl. CPC E21B 47/135; E21B 34/16; G08C 23/02

(57) ABSTRACT

Some implementations include a system configured for use in a wellbore drilled through one or more subsurface formations, the system comprising a first downhole tool positioned along a tubular in the wellbore and a first cable including one or more fiber optic cables, wherein the first cable is coupled with the tubular external to the first downhole tool. The system further includes a control system coupled with the first cable and a transceiver coupled to the first downhole tool, wherein the transceiver is configured to transmit an uplink transmission, via the one or more fiber optic cables, from the first downhole tool to the control system.

### TECHNICAL FIELD

The disclosure generally relates to wellbores formed in subsurface formations, and in particular, to wireless communications with inflow control devices positioned in a wellbore.

### BACKGROUND

Electronic inflow control devices (EICDs) may be deployed in a wellbore to aid in the recovery of more challenging reserves in lower quality formations. It may be desirable to use a wireless system to communicate with the EICDs downhole; however, deploying a true wireless system comes with several challenges. One such approach, which involves the use of fluid pulse telemetry, may not be preferable when compared to other options, and acoustic telemetry may sometimes be susceptible to downhole background noise interference. A different approach may use a spliced-in tubing encapsulated conductor (TEC) or fiber optic cable as is done with typical intelligent completions. However, rig floor splicing may be cost-prohibitive for many business cases. Other traditional systems may require TEC lines to be spliced to each tool, use batteries or acoustic telemetry nodes on each tool, etc. Splicing into each tool may be time consuming, costly, and introduce reliability concerns. For example, conventional techniques for splicing may take between six to twelve hours per tool. Considering multiple EICDs may be used per producing zone, and dozens, hundreds, or even thousands of EICDs may be used within a single wellbore, this becomes a substantial undertaking.

### BRIEF DESCRIPTION OF THE DRAWINGS

Implementations of the disclosure may be better understood by referencing the accompanying drawings.

FIG. 1 is an illustration depicting an example well system, according to some implementations.

FIG. 2 is a first cross-sectional diagram depicting an EICD mandrel, according to some implementations.

FIG. 3 is a second, closer cross-sectional view depicting the EICD mandrel of FIG. 2, according to some implementations.

FIG. 4 is a graph depicting a magnetic field presence over time detected by a magnetic field detector, according to some implementations.

FIG. 5 is an illustration depicting an example computer, according to some implementations.

FIG. 6 is a flowchart depicting an example method of operations, according to some implementations.

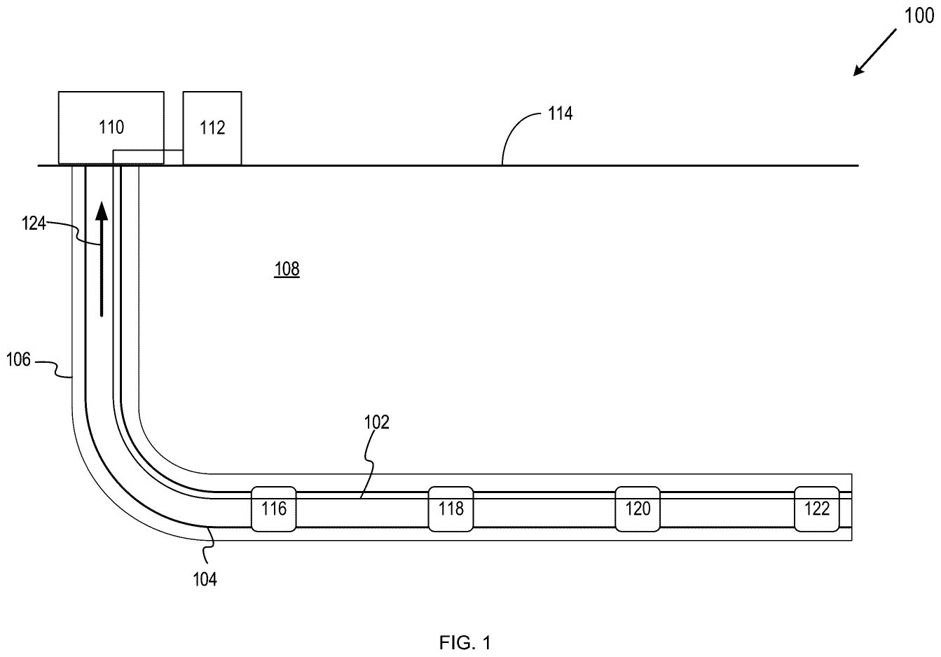

FIGS. 1-6 and the operations described herein are examples meant to aid in understanding example implementations and should not be used to limit the potential implementations or limit the scope of the claims. Some implementations may perform additional operations, fewer operations, operations in parallel or in a different order, and some operations differently.

The description that follows includes example systems, methods, techniques, and program flows that embody implementations of the disclosure. However, it is understood that this disclosure may be practiced without these specific details. In other instances, well-known instruction instances, protocols, structures, and techniques have not been shown in detail in order not to obfuscate the description.

### DESCRIPTION

To avoid the challenges of spliced-in systems, a hybrid TEC and fiber optic cable may be positioned over (not spliced into) an EICD to both send and receive data. The EICD may utilize downhole power generation to eliminate the need for short lived batteries or a wired connection to a surface power supply. To send a downlink to the EICD or similar downhole tool, the conductor may be selectively energized and de-energized in a particular sequence to send a command to a tool or group of tools. The tool may wirelessly receive the data without a hardwired connection based on detection of the induced magnetic field around the cable. Using this approach may allow a command to be sent through a TEC without the need for uneconomic splices into each tool on the rig floor. The uplink from the downhole tool to the surface may be sent in the form of acoustic data captured by the fiber optic cable. The downhole tool may be designed to give a clear acoustic signal upon valve closure or opening and in the presence of water production. Using this telemetry approach may eliminate the operational challenges associated with pulse telemetry and the susceptibility of interference with acoustics. Eliminating the use of direct splicing into each EICD may also reduce the total costs associated with ownership and operation of the system. This wireless technique may also provide a contingency design should operating acoustic telemetry in the presence of downhole turbines prove to be unreliable.

### Example Illustrations

FIG. 1 is an illustration depicting an example well system 100, according to some implementations. The example well system 100 includes a hybrid cable 102, a production tubing 104, a wellbore 106, a subsurface formation 108, a surface production system 110, a distributed sensing control system 112, a surface 114, electronic inflow control devices (EICDs) 116, 118, 120, and 122, and a production fluid 124. The production fluid 124 may travel from the subsurface formation 108 and into the production tubing 104 via the EICDs 116-122. The distributed sensing control system 112 may communicate with each EICD or a group of the EICDs 116-122 via the hybrid cable 102. The hybrid cable 102 may include one or more tubing encapsulated conductor (TEC) cables and one or more fiber optic cables. Each cable may include its own exterior insulation, and the TEC cables and fiber optic cables may be housed within the broader hybrid cable 102.

The hybrid cable 102 may be coupled directly to the distributed sensing control system 112 and indirectly coupled (i.e., wirelessly) coupled with the EICDs 116-122 to transmit and receive communications to and from the wellbore. In particular, the one or more fiber optic cables may be coupled to the distributed sensing control system 112 for communications. In some implementations, the distributed sensing control system 112 may include or may otherwise be coupled to a power source to energize and de-energize the conductors of the one or more TEC cables of the hybrid cable 102. This power source may comprise an alternating current (AC) or direct current (DC) power source and may be positioned at the surface 114, within the wellbore 106 uphole of the EICDs 116-122, etc. Energizing and de-energizing the TEC cable within the hybrid cable 102 may be used to transmit downlink commands to the EICDs 116-122. For example, each EICD may be configured to detect magnetic pulses around the conductor(s) of the hybrid cable 102. The magnetic pulses may be used to convey a command to any one of the EICDs 116-122 or a grouping of the EICDs.

The one or more fiber optic cables within the hybrid cable 102 may be configured to transmit uplink messages to the distributed sensing control system 112 from any one of the EICDs 116-122. In some implementations, the fibers within each fiber optic cable may be configured to detect an actuation of any one of the EICDs 116-122, a water cut of the production fluid 124, a fluid composition of the production fluid 124, etc. In one example, each EICD may include an impeller or turbine for downhole power generation. The turbine (or impeller) may be configured to intake fluid from the wellbore or the production fluid 124 from within the production tubing 104. The revolutions per minute (RPM) of the turbine may generate a noise detectable by the fiber optic cable which may be transmitted to the distributed sensing control system 112 for analysis. Also referred to as acoustic fluid analysis or acoustic spectroscopy, the distributed sensing control system 112 may determine a number of fluid properties including fluid composition, density, viscosity, etc. based on the uplink data sent from each of the EICDs 116-122. While only four EICDs are shown, the well system 100 may include any number of EICDs across one or more wellbores. For example, an example well may include over one hundred inflow control devices, and multiple may be designated for each production zone/interval.

Some traditional completions designs may communicate information to and from a downhole tool by increasing or decreasing production flow to increase or decrease the RPMs of the downhole turbine, respectively. However, this may be difficult in certain environments, such as in subsea wells or wells including a wellhead tree. Rather than modulating the flow of the production fluid 124 to communicate with the EICDs 116-122 (which may not be feasible for every well configuration), the hybrid cable 102 may instead use one or more conductors primarily for downlink transmissions to the EICDs 116-122 and one or more fiber optic cables primarily for uplink transmissions to the distributed sensing control system 112.

In some implementations, the distributed sensing control system 112 may be a distributed acoustic sensing (DAS) control system configured to analyze acoustic uplink signals along the fiber optic cable of the hybrid cable 102 from each of the EICDs 116-122. The DAS control system may also be configured to energize and de-energize to send an acoustic downlink signal via the hybrid cable 102 to one or more of the EICDs 116-122.

In some implementations, the distributed sensing control system 112 may be a distributed temperature sensing (DTS) control system configured to measure the temperature across the fiber optic cable of the hybrid cable 102. Each of the EICDs 116-122 may include functionality to generate heat substantial enough to differentiate from the ambient downhole environment. For example, each of the EICDs 116-122 may generate a heat signature proximate to the fiber optic cable downhole. This applied heat may be used to signal that a downlink command has been implemented. This confirmation via heat signature may be detected by the DTS system. The distributed sensing control system 112 may be a DAS system or DTS system depending on the software or algorithm used by the control system and the grade of the fiber within the hybrid cable 102. In some implementations, the distributed sensing control system 112 may be a hybrid control system capable of both DAS and DTS analysis. In this configuration, the hybrid cable 102 may include at least two fiber optic cables; one for DAS and one for DTS. The DAS and DTS fibers may be packaged within the same fiber bundle or within separate bundles of the hybrid cable 102. While the hybrid cable 102 may be hardwired into the distributed sensing control system 112, the hybrid cable 102 may communicate wirelessly with the EICDs 116-122. In some implementations, the distributed sensing control system 112 may be a distributed vibration sensing (DVS) control system. The distributed sensing control system 112 may also be configured as a combined DAS, DTS, and DVS system. Other configurations may also be possible.

While the wellbore 106 is depicted as a singular wellbore, the well system 100 may also comprise multiple wellbores. For example, the hybrid cable 102 and distributed sensing control system 112 may be configured for use in a multi-lateral (MLT) well including two or more wellbores. A primary hybrid cable, which may be similar to the hybrid cable 102, may extend from the distributed sensing control system 112 to a mandrel or downhole tool uphole of any wellbore junctions and uphole of the EICDs 116-122. The primary hybrid cable may communicatively and electrically couple with a first end of the mandrel. For example, the primary hybrid cable may couple with a first end of the mandrel via a wet mate stabbing connection. Other connection types may also be possible. At a second end of the mandrel, one or more secondary hybrid cables may be coupled to the mandrel. The secondary hybrid cables may also be communicatively and electrically coupled with the mandrel. One hybrid cable may extend from the mandrel into each lateral wellbore of the MLT well, and each lateral wellbore may include a production tubing including one or more EICDs. The mandrel may include a means by which to communicatively and electrically couple the primary hybrid cable to the secondary hybrid cables. For example, the mandrel may capacitively couple the TEC cable of the primary hybrid cable with the TEC cables of the secondary hybrid cables downhole. The mandrel may utilize capacitive charging, magnetic induction, etc. to electrically couple the primary and secondary hybrid cables. The primary hybrid cable may also include at least one fiber optic cable per lateral wellbore. Thus, electrical power may be communicated between the primary hybrid cables and secondary hybrid cables via the mandrel to send downlink signals to EICDs in each lateral, and uplink communications from the EICDs in each lateral may be communicated to the distributed sensing control system 112. The downlink communications to the EICDs and uplink communications from the EICDs may be performed wirelessly, and each secondary hybrid cable (e.g., two or more) may be coupled to the primary hybrid cable via the mandrel. Hence, communications with the EICDs in the lateral wellbores may be received and/or generated by the distributed sensing control system 112. Other means of coupling tools positioned in multiple lateral wellbores to a surface system may also be possible.

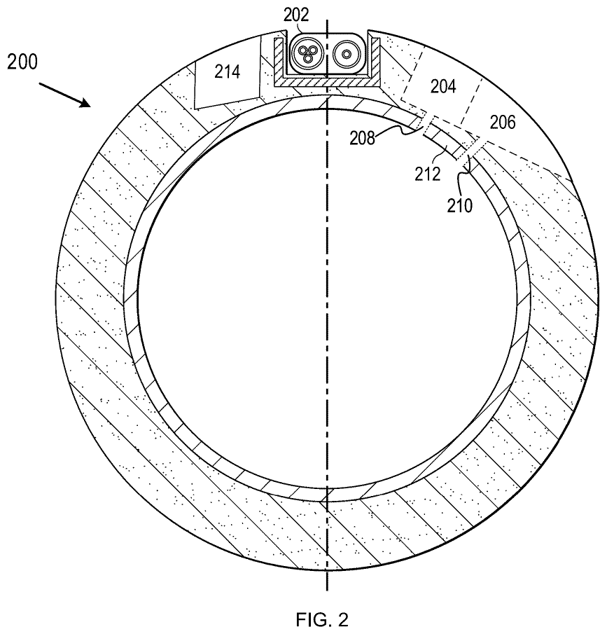

FIG. 2 is a first cross-sectional diagram depicting an EICD mandrel 200, according to some implementations. The EICD mandrel 200 includes a hybrid cable 202, a valve 204, a power source 206, a valve inlet 208, a power source inlet 210, a pipe inner diameter (ID) 212, and a processing printed circuit board (PCB) 214. The processing PCB 214 may function as a microcontroller to control one or more components of the EICD mandrel 200. Additionally, the processing PCB 214 may be a transceiver configured to decode downlink communications from a surface or sub-surface control system (e.g., the distributed sensing control system 112) and encode uplink communications to said control system. The processing PCB 214 of each EICD mandrel 200 may have a unique address or channel and may be addressed by a unique signal from the distributed sensing control system. As such, each processing PCB 214 of each EICD mandrel 200 may be able to determine whether downlink communications are addressed to their unique unit, a group of EICDs, or whether a downlink communication is addressed to other EICDs. Various communication techniques may be used to communicate downlink transmissions to the EICDs and uplink transmissions from the EICDs to the surface. Such communication techniques may include a binary encoding scheme created and/or used by an operator, frequency shift keying (FSK), American Standard Code for Information Exchange (ASCII), etc. Other communication schemes may also be used. These communication techniques may be used to address individual processing PCBs 214 or a grouping of processing PCBs 214 across multiple EICD mandrels. The processing PCBs may be configured to always listen for downlink commands and may be configured to recognize and/or decode sequences from the surface. The processing PCBs may also be configured to generate uplink sequences via the EICD mandrel 200.

The power source 206 may be configured to provide power to at least the valve 204 and processing PCB 214. In some implementations, the power source 206 may comprise a power generation or power storage device. For example, the power source 206 may include a generator configured to generate power from fluid flow within the pipe ID 212. The generator may include a fluid-driven impulse turbine or an impeller used to power the tools of each EICD mandrel 200, such as the processing PCB 214, valve 204, a motor configured to open or close the valve 204, etc. Production fluid within the pipe ID 212 may flow into the turbine or impeller via the power source inlet 210. The inflow through the power source inlet 210 may be converted into rotational energy, and from rotational energy into electrical power. However, the power source 206 may comprise any other means to provide power to the components of the EICD mandrel 200 downhole. For example, the power source 206 may include a battery configured for use in a subsurface environment with an operating life greater than five years, such as a betavoltaic battery. Other implementations of the power source 206 may use a radioisotope thermoelectric generator to provide power the EICD mandrel 200. Any other downhole power generation or power storage system configured for long-term use (in excess of five years) may also be possible. Utilizing long-term downhole power generation and/or storage and by avoiding direct splicing of downhole components may enable each of the EICD mandrels 200 to operate for at least five years within a wellbore.

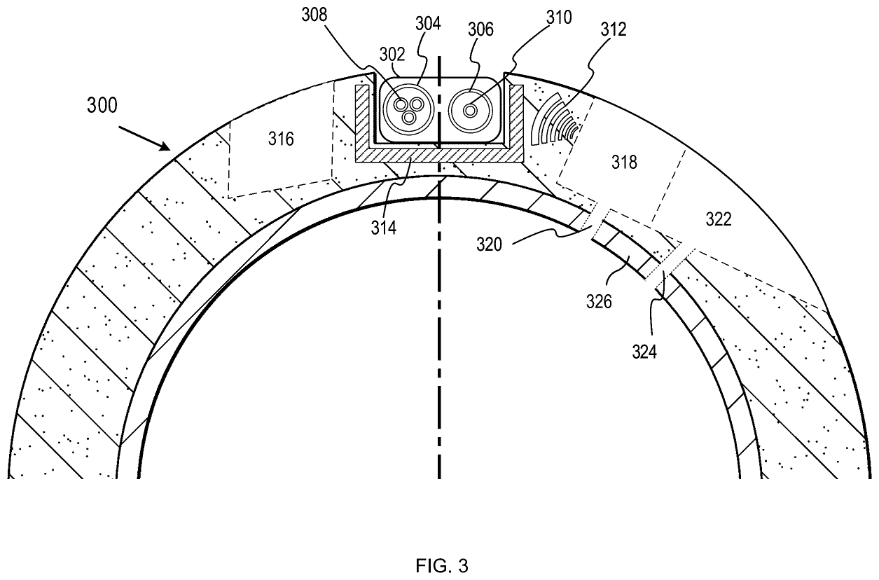

FIG. 3 is a second, closer cross-sectional view depicting the EICD mandrel of FIG. 2, according to some implementations. The EICD mandrel 300, which may be similar to the EICD mandrel 200 of FIG. 2, includes many of the same components described in FIG. 2. For example, the EICD mandrel 300 includes a hybrid cable 302, a TEC cable 304, a fiber optic cable 306, one or more conductors 308, one or more fibers 310, an output signal 312, a magnetic field detector 314, a processing PCB 316, a valve 318, a valve inlet 320, a power source 322, a power source inlet 324, and a pipe ID 326. The valve 318 may be an inflow control device such as an electronic inflow control device (EICD), an autonomous inflow control device (AICD), etc.

The hybrid cable 302 may include the tubing encapsulated conductor (TEC) cable 304 including one or more conductors 308. The hybrid cable 302 may also include the fiber optic cable 306 including one or more fibers 310. The conductors 308 may be selectively energized and de-energized from surface to communicate a command to the EICD mandrel 300. The signal may be received and by the processing PCB 316 which may be coupled to the valve 318. The processing PCB 316 may output a command based on the signal to induce an action at the valve 318.

The fiber optic cable 306 may include one or more of the fibers 310. The fibers 310 may include one or more single-mode fibers, multi-mode fibers, or a combination of single-mode and multi-mode optical fibers. The fiber optic cable 306 may include an exterior protective layer comprised of a polymer or metal. The TEC cable 304 may include an exterior protective layer comprised of a metal tubing. The metal tubing of the TEC cable 304 may be comprised of stainless steel, nickel alloy, etc. Some implementations of the TEC cable 304 may include an exterior protective layer comprised of a polymer. Similarly, the hybrid cable 302 may also include an exterior protective layer comprised of a polymer, a metal, etc. which may be configured to survive in a subsurface environment (i.e., possessing corrosion resistance).

The hybrid cable 302 may be positioned along an exterior of the EICD mandrel 300. In some implementations, the hybrid cable 302 may be clamped or otherwise attached to an exterior of a production tubing, such as the production tubing 104, and may pass along an outer surface each EICD mandrel 300. In some implementations, the hybrid cable 302 may be positioned proximate to the valve 318 without a direct wired electrical connection to the valve 318.

In some implementations, each EICD mandrel 300 may include other downhole tools. For example, the EICD mandrel 300 may include one or more sensors which may be configured to measure a property of the fluid within the pipe ID 326, a fluid within the wellbore external to the EICD mandrel 300, etc. The sensors may also include temperature sensors, flow rate sensors, fluid phase sensors, pressure sensors, etc. In one example, the EICD mandrel 300 may include a pressure sensor configured to measure a wellbore pressure around the EICD mandrel 300, a pressure within the pipe ID 326, etc. The measurements from this pressure sensor may be encoded via the processing PCB 316 and transmitted to a surface unit via the fibers 310 of the fiber optic cable 306. Other downhole tools may also refer to tools external to the EICD mandrel 300 including a packer, sliding side door (SSD) sleeve, retrievable plug, a formation sampling device, etc. Other downhole tools configured to communicate wirelessly via the hybrid cable 302 may also be possible.

Selectively energizing and de-energizing the conductors 308 may induce changes in a magnetic field or the presence of the magnetic field around the TEC cable 304 which may be measured by the magnetic field detector 314. For example, selectively energizing and de-energizing the conductors 308 may generate and collapse the magnetic field in a specific sequence. This sequence may be used to transmit a message or command. The magnetic field detector 314 may include any one of a Hall effect sensor, magneto-resistive sensor, anisotropic magneto-resistive sensor (AMR), tunnel magneto-resistive (TMR) sensor, an inductive coil sensor, etc. to measure the presence of and magnitude of the magnetic field generated via the TEC cable 304. Other magnetic field detectors may also be possible. A control system at the surface, such as the distributed sensing control system 112, may utilize the magnetic field fluctuations to transmit downlink commands to the EICD mandrel 300. Measurements from the magnetic field detector 314 may be received and deciphered via the processing PCB 316 to decode a transmitted message.

Magnetic field fluctuations may be generated by varying a voltage or current sent through the conductors 308 of the TEC cable 304. The magnetic field, both in its presence and in how it changes over time, may convey a command to the processing PCB 316. For example, simply energizing and de-energizing the conductors 308 over set time intervals may convey a command recognizable by the processing PCB 316. In some implementations, data may be encoded in the magnetic field by varying its magnitude. For example, data or commands may be encoded transmitted to the processing PCB 316 from the surface by varying current amperage, voltage amplitude shifts, voltage phase shifts, voltage frequency shifts, timing shifts, etc. through the TEC cable 304. In addition to simply using the TEC cable 304 to send a downlink in the form of magnetic field variations, it may be possible to use the conductors 308 to send uplinks. By inducing a current in the one or more conductors 308 at each EICD, a response may be transmitted directly to the surface in the TEC cable 304 or repeated by each node (e.g., each EICD, each acoustic node, etc.) in a string.

While the TEC 304 may be used primarily to send downlink transmissions to the EICDs in the wellbore, the fiber optic cable 306 may primarily be used to send an uplink to the surface. There may be various ways to communicate a message to the surface. A DAS system at the surface may be configured to receive acoustic signals from the EICD mandrel 300, a DTS system at the surface may be configured to receive temperature data from the EICD mandrel 300, a DVS system may be configured to receive vibrational measurements from the EICD mandrel 300, etc.

Using an acoustic signal transmission configuration, the output signal 312 may comprise an acoustic signal which may be detected by the one or more fibers 310. The one or more fibers 310 of the fiber optic cable 306 may continuously listen for acoustic signals downhole. The opening and closing of the valve 318 may generate a noise detectable by fiber(s) 310, represented by the output signal 312. For example, the EICD mandrel 300 may include a small electric motor which may be powered by the power source 322. The motor may be configured to open or close the valve 318. The fibers 310 of the fiber optic cable 306 may detect the noise generated by the downhole motor as it opens/closes the valve 318. This output signal 312 may be communicated via the fiber optic cable 306 to a control system at the surface as a confirmation that the valve has been actuated. The fiber optic cable 306 may continuously monitor for output signals 312 generated by actuation of the valve 318. In some implementations, the fibers 310 may also detect acoustic signals generated by water production through the valve 318.

Rather than transmitting a simple confirmation of valve actuation to a surface control system via the fiber optic cable 306, more complex messages may be transmitted to the surface via an acoustic output signal. For example, processing PCB 316 may encode a message in sounds generated via the opening/closing of the valve 318, increased/decreased RPMs of the power source 322 (in configurations using a downhole turbine), actuation of the small electric motor, etc. The uplink message may be encoded using binary encoding, frequency shift keying (FSK), American Standard Code for Information Exchange (ASCII), etc.

While the fiber(s) 310 of the fiber optic cable 306 may be configured to detect acoustic signals, other acoustic signals downhole may generate signal noise. In some implementations, temperature sensing may be used by the EICD mandrel 300 to generate uplink messages. A DTS system positioned uphole may be configured to detect heat signatures from one or more EICDs which may be registered by the fiber optic cable 306. The EICD mandrel 300 may include a heating element, such as a resistive heating element, which may generate heat greater than an ambient heat in the wellbore. For example, a resistance heater may be used to warm the fiber optic cable 306 relative to a background heat signature to send data in an uplink message, give confirmation that a command was executed, etc. The resistive heating element may be powered via the power source 322. However, other heating elements may be possible. The heating element may be positioned proximate to the fiber optic cable 306 such that the one or more fibers 310 detect the heat influx from the heating element.

In one example, the heating element may be used to generate an uplink signal to confirm the execution of a downlink command. For example, a command may be sent from a distributed temperature sensing control system to the EICD mandrel 300. The command may be detected as magnetic field fluctuations by the magnetic field detector 314 and deciphered by the processing PCB 316. The command may instruct the processing PCB 316 to open the valve by a certain percentage to enable additional production. Once this command is received and executed by the processing PCB 316, the processing PCB 316 may generate an uplink confirmation to the DTS control system by heating the heating element. This additional heat proximate to the fiber optic cable 306, which may also be an output signal 312, may be detected by the DTS control system. More complex messages may also be sent via the heating element. For example, applying heat over a specified time interval (e.g., lasting ten seconds) and halting heat supply, multiple sequences of applying and halting heat supply, etc. may be used to encode messages to the DTS control system. Similar to the DAS system above, the uplink message to the DTS control system may be encoded using binary encoding, frequency shift keying (FSK), American Standard Code for Information Exchange (ASCII), etc.

In another example configuration, the EICD mandrel 300 may include a vibrational element to induce vibrations at the EICD detectable by a DVS system at the surface. Rather than simply using the fiber optic cable 306 to listen for acoustic signals which may be subject to background noise downhole, a system may be installed on the EICD mandrel 300 to move or directly vibrate the fiber optic cable 306. In some implementations, this may include a piezoelectric system powered by the power source 322. The piezoelectric system may be in contact with the fiber optic cable 306 or positioned proximate to the fiber optic cable 306. The vibrational system may use mechanical intervention of the fiber optic cable 306 to generate the output signal 312 via vibration. This vibrational output signal may be used to send a clear signature that may be identified in the noise. In addition to a piezoelectric system, other components may be used to generate the vibration detectable by the fiber optic cable 306. For example, the power source 322 may include a generator configured to generate vibrations detectable by the fiber optic cable 306. In some implementations, a small electric motor may also be configured to generate vibrations within the EICD mandrel 300 to encode an uplink message detectable by the fibers 310 of the fiber optic cable 306. The uplink message may include a sequence of vibrations and halting vibration to encode an uplink message. The vibrational element may vibrate over a set time period which may be equal to 1 in a binary encoding scheme, and a lack of vibration over the time period may be interpreted as a 0. Other communication techniques using the vibrational element may be possible. The processing PCB 316 may encode an uplink message using the vibrational element to be received by a DVS control system, the uplink message encoded using binary encoding, frequency shift keying (FSK), American Standard Code for Information Exchange (ASCII), etc. Other encoding schemes including morse code may be used by a processing PCB to encode acoustic output signals, temperature output signals, and vibrational output signals to communicate with a surface control system. In essence, a parameter may be varied over time in a sequence to generate an uplink message to travel along the fiber optic cable 306.

One or more of the EICD mandrels 300 and distributed sensing control system at the surface may form an autonomous completions system. The EICD, referred to as an autonomous inflow control valve (AICD) in an autonomous system, may be configured to output confirmations of executed commands. The commands may be received from a distributed sensing control system uphole and decoded by the processing PCB 316. The valve 318 may be actuated according to the command, and one or more output signals 312 may be transmitted to the fiber optic cable 306 back to the distributed sensing control system.

The autonomous system may also be self-adjusting, and actions performed by each of the EICDs may be transmitted to the surface. Some implementations of the processing PCB 316 may actuate the valve 318 to open or close based on a measured property. In some implementations, the processing PCB 316 may perform an action at the EICD mandrel 300 (or AICD) and send an output signal 312 to the surface detailing the action. For example, the processing PCB 316 may close the valve 318 based on a pressure measurement from a pressure sensor on the EICD mandrel 300. The closure of the valve 318 may be performed autonomously by the processing PCB 316. The processing PCB 316 may encode a message detailing the closure, the reason the closure, and a pressure measurement from the pressure sensor. Other example scenarios may also be possible.

In some implementations, downhole EICDs may also communicate with one another by forwarding communications through the distributed sensing control system. For example, a processing PCB may encode a message to send to a separate EICD mandrel, a separate downhole tool, or a group of downhole tools based on their unique address. The encoded message may include a command to the distributed sensing control system to encode the desired command from the sender tool to be received at the requested tool or tool grouping. Other example scenarios may also be possible.

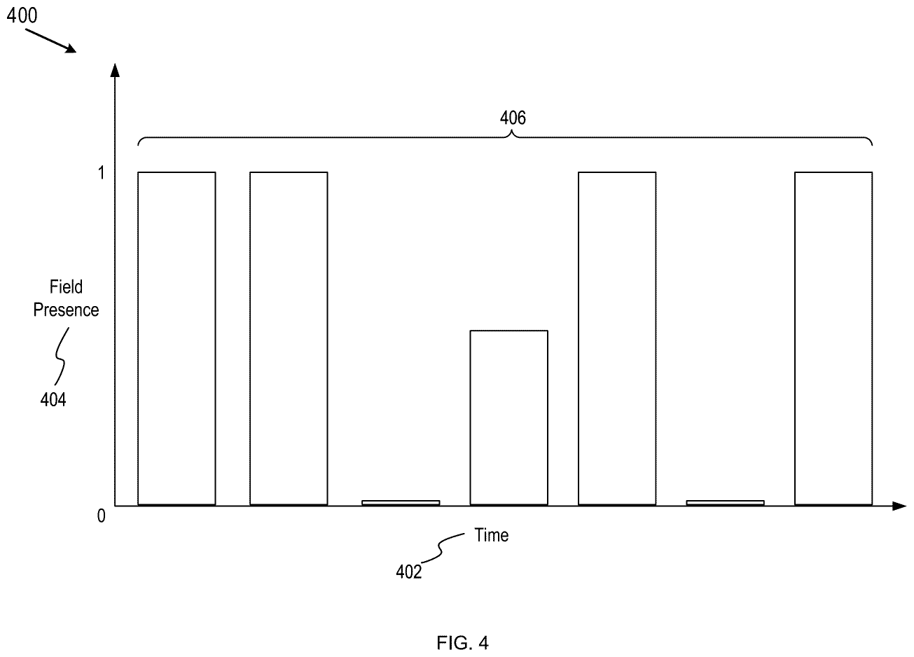

FIG. 4 is a graph 400 depicting a magnetic field presence over time detected by a magnetic field detector, according to some implementations. The graph 400 includes an X-axis 402 depicting a time in arbitrary units and a Y-axis 404 depicting a field presence of a magnetic field. A magnetic field detector, such as the magnetic field detector 314, may be configured to measure the magnetic field (or lack thereof) around the TEC cable 304. The magnetic field may be present or absent during certain time intervals based on the energization or de-energization of the conductors of the TEC cable. The magnetic field may also have different strengths over a certain time interval. The changing of the magnetic field over a time interval may form a sequence 406. While only seven measurement intervals are depicted in the sequence 406, any number of magnetic field measurements may be included in the sequence 406.

The sequence 406 may encode a specific message to an EICD or grouping of EICDs within the well. The sequence may utilize a binary encoding scheme to convey commands to the EICDs, although other means of communication may also be used. For example, the sequence 406 may include a binary scheme in which peaks of the magnetic field may be equal to 1 and valleys make be equal to 0. In a different binary encoding scheme, the presence of a magnetic field at all may be equal to 1, whereas an absence of the magnetic field over a set interval of time may be equal to 0. Other encoding techniques may be possible.

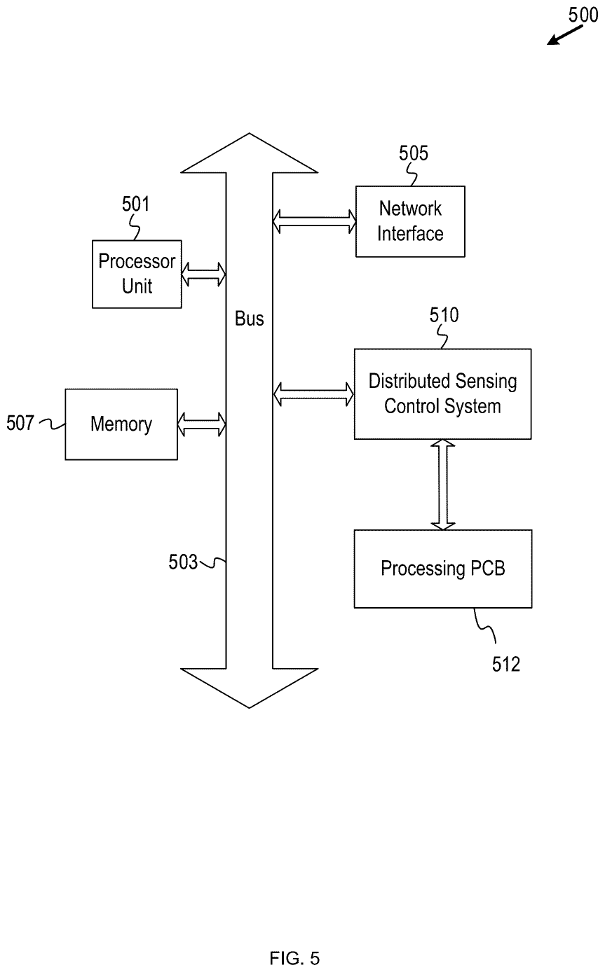

FIG. 5 is an illustration depicting an example computer 500, according to some implementations. The computer 500 may include a processor 501 (possibly including multiple processors, multiple cores, multiple nodes, and/or implementing multi-threading, etc.). The computer system may include memory 507. The memory 507 may be system memory or any one or more of the above already described possible realizations of machine-readable media. The computer system may also include a bus 503 and a network interface 505. The system may communicate via transmissions to and/or from remote devices via the network interface 505 in accordance with a network protocol corresponding to the type of network interface, whether wired or wireless and depending upon the carrying medium. In addition, a communication or transmission may involve other layers of a communication protocol and or communication protocol suites (e.g., transmission control protocol, Internet Protocol, user datagram protocol, virtual private network protocols, etc.).

The computer 500 may further include a distributed sensing control system 510. The distributed sensing control system 510 may be similar to the distributed sensing control system 112 of FIG. 1. The distributed sensing control system 510 may be configured to generate downlink commands to one or more processing PCBs 512 via a TEC cable. The processing PCBs 512 may be coupled to one or more tools in a wellbore. The distributed sensing control system 510 may also be configured to receive and decode uplink communications from the processing PCB 512 via a fiber optic cable, the TEC cable, etc.

The distributed sensing control system 510 may include a signal processor to perform various signal processing operations on received signals. The distributed sensing control system 510 may be configured to graphically represent analysis results on a display device. The distributed sensing control system 510 may operate using various sensing principles including, but not limited, to amplitude-based sensing systems such as DTS, DAS, DVS, Distributed Strain Sensing (DSS), etc. In some implementations, the DTS system may be based on Raman scattering, Brillouin scattering, etc. A DAS system may comprise a phase sensing-based system based on interferometric sensing using homodyne or heterodyne techniques where the system may sense phase or intensity changes due to constructive or destructive interference. The DAS system may also be based on Rayleigh scattering and, in particular, coherent Rayleigh scattering. Other techniques may also be possible.

Any one of the previously described functionalities may be partially (or entirely) implemented in hardware and/or on the processor 501. For example, the functionality may be implemented with an application specific integrated circuit, in logic implemented in the processor 301, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

### Example Method of Operations

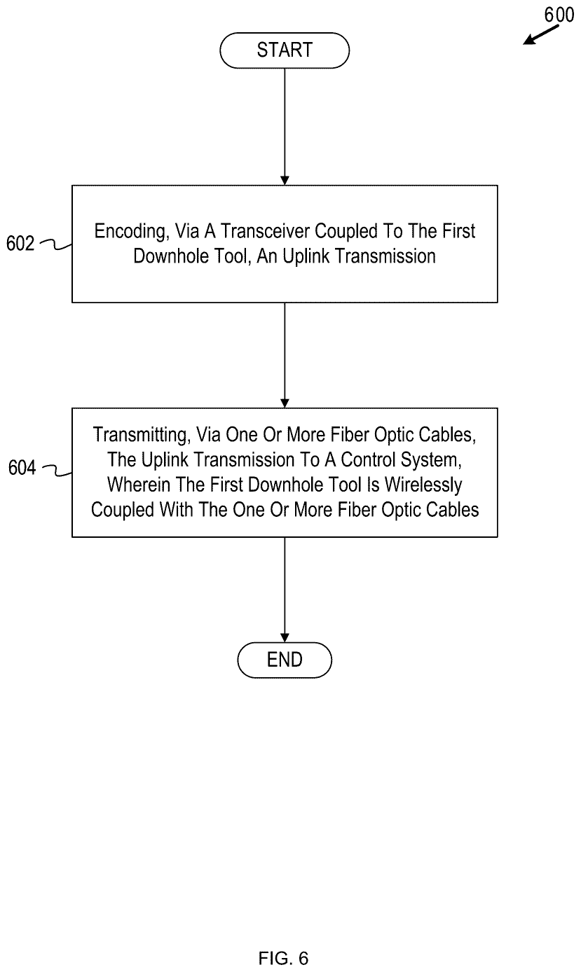

FIG. 6 is a flowchart depicting an example method of operations, according to some implementations. Operations of a method 600 may include generating a first uplink transmission from a first downhole tool positioned in a wellbore formed in one or more subsurface formations to a control system positioned at a surface of the wellbore. Operations of the method 600 may be performed by software, firmware, hardware, or a combination thereof. Such operations are described with reference to FIGS. 1-5. However, such operations may be performed by other systems or components. The operations of the method 600 begin at block 602.

At block 602, the method 600 includes encoding, via a transceiver coupled to the first downhole tool, an uplink transmission. For example, a first downhole tool, such as the EICD mandrel 300, may include an inflow control device such as the valve 318, and a transceiver such as the processing PCB 316. The processing PCB 316 may encode an uplink transmission to transmit from the EICD mandrel 300 to a control system such as the distributed sensing control system 112. The processing PCB 316 may encode a simple communication, such as a confirmation of an executed command, or the processing PCB 316 may encode a more complex message to transmit to the distributed sensing control system 112. Flow progresses to block 604.

At block 604, the method 600 includes transmitting, via one or more fiber optic cables, the uplink transmission to the control system, wherein the first downhole tool is wirelessly coupled with the one or more fiber optic cables. For example, the uplink transmission may be transmitted via the fiber optic cable 306 to the distributed sensing control system by the output signal 312. The output signal 312 may include an acoustic signal, a temperature spike, or a vibration detectable by the one or more fibers 310. The output signal 312 may be a point transmission for a simple confirmation of an executed command, or the output signal 312 may include a sequence of signals to transmit more complex communications. Flow of the method 600 ceases.

### Example Implementations

### Example Implementations Include the Following:

Implementation #1: A system configured for use in a wellbore drilled through one or more subsurface formations, the system comprising: a first downhole tool positioned along a tubular in the wellbore; a first cable including one or more fiber optic cables, wherein the first cable is coupled with the tubular external to the first downhole tool; a control system coupled with the first cable; and a transceiver coupled to the first downhole tool, wherein the transceiver is configured to transmit an uplink transmission, via the one or more fiber optic cables, from the first downhole tool to the control system.

Implementation #2: The system of Implementation 1, further comprising: a downhole power source coupled with the first downhole tool, wherein the downhole power source is configured to provide power to the first downhole tool; one or more tubing encapsulated conductor (TEC) cables each including one or more conductors, wherein the one or more TEC cables are housed within the first cable; and a magnetic field detector coupled to the first downhole tool and the transceiver, wherein the first downhole tool comprises an inflow control device (ICD).

Implementation #3: The system of any one or more of Implementations 1-2, wherein the control system is configured to transmit a downlink transmission to the first downhole tool via the one or more TEC cables, wherein the downlink transmission is transmitted by a selective energization and de-energization of the one or more TEC cables to generate and collapse a magnetic field over a time interval, and wherein the magnetic field is detectable by the magnetic field detector.

Implementation #4: The system of any one or more of Implementations 1-3, wherein the transceiver is configured to transmit the uplink transmission via the one or more TEC cables.

Implementation #5: The system of any one or more of Implementations 1-4, wherein the first downhole tool includes a heating element, wherein a heat applied to the one or more fiber optic cables transmits the uplink transmission, and wherein the control system comprises a distributed temperature sensing (DTS) system.

Implementation #6: The system of any one or more of Implementations 1-5, wherein the uplink transmission includes one or more acoustic output signals generated by the first downhole tool, and wherein the control system comprises a distributed acoustic sensing (DAS) system.

Implementation #7: The system of any one or more of Implementations 1-6, wherein the first downhole tool includes a vibrational device, wherein the uplink transmission includes one or more vibrational output signals, and wherein the control system comprises a distributed vibrational sensing (DVS) system.

Implementation #8: An apparatus configured for use in a wellbore formed in one or more subsurface formations, the apparatus comprising: a first downhole tool positioned along a tubular in the wellbore; a first cable including one or more fiber optic cables, wherein the first cable is coupled with the tubular external to the first downhole tool; and a transceiver coupled to the first downhole tool, wherein the transceiver is configured to transmit an uplink transmission, via the one or more fiber optic cables, from the first downhole tool.

Implementation #9: The apparatus of Implementation 8, further comprising: a control system coupled with the first cable, wherein the transceiver is configured to transmit the uplink transmission from the first downhole tool to the control system.

Implementation #10: The apparatus of any one or more of Implementations 8-9, further comprising: a downhole power source coupled with the first downhole tool, wherein the downhole power source is configured to provide power to the first downhole tool; one or more tubing encapsulated conductor (TEC) cables each including one or more conductors, wherein the one or more TEC cables are housed within the first cable; and a magnetic field detector coupled to the first downhole tool and the transceiver, wherein the first downhole tool comprises an inflow control device (ICD).

Implementation #11: The apparatus of any one or more of Implementations 8-10, wherein a control system is configured to transmit a downlink transmission to the first downhole tool via the one or more TEC cables, wherein the downlink transmission is transmitted by a selective energization and de-energization of the one or more TEC cables to generate and collapse a magnetic field over a time interval, and wherein the magnetic field is detectable by the magnetic field detector.

Implementation #12: The apparatus of any one or more of Implementations 8-11, wherein the transceiver is configured to transmit the uplink transmission via the one or more TEC cables.

Implementation #13: The apparatus of any one or more of Implementations 8-12, wherein the first downhole tool includes a heating element, wherein a heat applied to the one or more fiber optic cables transmits the uplink transmission, and wherein the control system comprises a distributed temperature sensing (DTS) system.

Implementation #14: The apparatus of any one or more of Implementations 8-13, wherein the uplink transmission includes one or more acoustic output signals generated by the first downhole tool, and wherein the control system comprises a distributed acoustic sensing (DAS) system.

Implementation #15: The apparatus of any one or more of Implementations 8-14, wherein the first downhole tool includes a vibrational device, wherein the uplink transmission includes one or more vibrational output signals, and wherein the control system comprises a distributed vibrational sensing (DVS) system.

Implementation #16: A method comprising: generating an uplink transmission from a first downhole tool positioned in a wellbore formed in one or more subsurface formations to a control system positioned at a surface of the wellbore, wherein generating the uplink transmission comprises, encoding, via a transceiver coupled to the first downhole tool, the uplink transmission, and transmitting, via one or more fiber optic cables, the uplink transmission to the control system, wherein the first downhole tool is wirelessly coupled with the one or more fiber optic cables.

Implementation #17: The method of Implementation 16, further comprising: selectively energizing one or more conductors of a tubing encapsulated conductor (TEC) cable to generate and collapse a magnetic field over time, wherein selectively energizing the one or more conductors encodes a downlink transmission from the control system; detecting, via a magnetic field detector of the first downhole tool, the magnetic field; and decoding, via the transceiver, the downlink transmission.

Implementation #18: The method of any one or more of Implementations 16-17, wherein transmitting the uplink transmission comprises: applying, via a heating element, a heat to the one or more fiber optic cables, wherein the control system is a distributed temperature sensing (DTS) system.

Implementation #19: The method of any one or more of Implementations 16-18, wherein transmitting the uplink transmission comprises: generating, via the first downhole tool, one or more acoustic output signals, wherein the control system comprises a distributed acoustic sensing (DAS) system.

Implementation #20: The method of any one or more of Implementations 16-19, wherein transmitting the uplink transmission comprises: generating, via a vibrational element of the first downhole tool, one or more vibrational output signals, wherein the control system comprises a distributed vibrational sensing (DVS) system.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described as acting in certain combinations and even initially claimed as such, one or more features from a claimed combination may in some cases be excised from the combination, and the claimed combination may be directed to a sub-combination or variation of a sub-combination.

While operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

The various illustrative logics, logical blocks, modules, circuits, and algorithm processes described in connection with some of the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the implementations disclosed herein may be implemented or performed with a general purpose single-or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor or any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more implementations, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, e.g., one or more modules of computer program instructions stored on a computer storage media for execution by, or to control the operation of, a computing device.

If implemented in software, the functions may be stored on or transmitted over as one or more instructions or code on a computer-readable medium. The processes of a method or algorithm disclosed herein may be implemented in a processor-executable instructions which may reside on a computer-readable medium. Computer-readable media includes both computer storage media and communication media including any medium that may be enabled to transfer a computer program from one place to another. Storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-Ray™ disc where disks usually reproduce data magnetically, while discs reproduce data optically with lasers. Combinations also may be included within the scope of computer-readable media. Additionally, the operations of a method or algorithm may reside as one or any combination or set of codes and instructions on a machine readable medium and computer-readable medium, which may be incorporated into a computer program product.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” may be infringed with only one of the listed items, multiple of the listed items, and one or more of the items in the list and another item not listed. Similarly, “at least one of: a, b, or c” is intended to cover: a, b, c, a-b, a-c, b-c, and a-b-c.

Unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well may be horizontal or even slightly directed upwards. Unless otherwise specified, use of the terms “subsurface formation” or “subterranean formation” shall be construed as encompassing both areas below exposed earth and areas below earth covered by water such as ocean or fresh water.

What is claimed is:

1. A system configured for use in a wellbore drilled through one or more subsurface formations, the system comprising:
a first downhole tool positioned along a tubular in the wellbore;
a first cable including one or more fiber optic cables, wherein the first cable is coupled with the tubular external to the first downhole tool;
a control system coupled with the first cable; and
a transceiver coupled to the first downhole tool, wherein the transceiver is configured to transmit an uplink transmission, via the one or more fiber optic cables, from the first downhole tool to the control system.

2. The system of claim 1, further comprising:
a downhole power source coupled with the first downhole tool, wherein the downhole power source is configured to provide power to the first downhole tool;
one or more tubing encapsulated conductor (TEC) cables each including one or more conductors, wherein the one or more TEC cables are housed within the first cable; and
a magnetic field detector coupled to the first downhole tool and the transceiver, wherein the first downhole tool comprises an inflow control device (ICD).

3. The system of claim 2, wherein the control system is configured to transmit a downlink transmission to the first downhole tool via the one or more TEC cables, wherein the downlink transmission is transmitted by a selective energization and de-energization of the one or more TEC cables to generate and collapse a magnetic field over a time interval, and wherein the magnetic field is detectable by the magnetic field detector.

4. The system of claim 2, wherein the transceiver is configured to transmit the uplink transmission via the one or more TEC cables.

5. The system of claim 1, wherein the first downhole tool includes a heating element, wherein a heat applied to the one or more fiber optic cables transmits the uplink transmission, and wherein the control system comprises a distributed temperature sensing (DTS) system.

6. The system of claim 1, wherein the uplink transmission includes one or more acoustic output signals generated by the first downhole tool, and wherein the control system comprises a distributed acoustic sensing (DAS) system.

7. The system of claim 1, wherein the first downhole tool includes a vibrational device, wherein the uplink transmission includes one or more vibrational output signals, and wherein the control system comprises a distributed vibrational sensing (DVS) system.

8. An apparatus configured for use in a wellbore formed in one or more subsurface formations, the apparatus comprising:
a first downhole tool positioned along a tubular in the wellbore;
a first cable including one or more fiber optic cables, wherein the first cable is coupled with the tubular external to the first downhole tool; and
a transceiver coupled to the first downhole tool, wherein the transceiver is configured to transmit an uplink transmission, via the one or more fiber optic cables, from the first downhole tool.

9. The apparatus of claim 8, further comprising:
a control system coupled with the first cable, wherein the transceiver is configured to transmit the uplink transmission from the first downhole tool to the control system.

10. The apparatus of claim 8, further comprising:
a downhole power source coupled with the first downhole tool, wherein the downhole power source is configured to provide power to the first downhole tool;
one or more tubing encapsulated conductor (TEC) cables each including one or more conductors, wherein the one or more TEC cables are housed within the first cable; and
a magnetic field detector coupled to the first downhole tool and the transceiver, wherein the first downhole tool comprises an inflow control device (ICD).

11. The apparatus of claim 10, wherein a control system is configured to transmit a downlink transmission to the first downhole tool via the one or more TEC cables, wherein the downlink transmission is transmitted by a selective energization and de-energization of the one or more TEC cables to generate and collapse a magnetic field over a time interval, and wherein the magnetic field is detectable by the magnetic field detector.

12. The apparatus of claim 10, wherein the transceiver is configured to transmit the uplink transmission via the one or more TEC cables.

13. The apparatus of claim 9, wherein the first downhole tool includes a heating element, wherein a heat applied to the one or more fiber optic cables transmits the uplink transmission, and wherein the control system comprises a distributed temperature sensing (DTS) system.

14. The apparatus of claim 9, wherein the uplink transmission includes one or more acoustic output signals generated by the first downhole tool, and wherein the control system comprises a distributed acoustic sensing (DAS) system.

15. The apparatus of claim 9, wherein the first downhole tool includes a vibrational device, wherein the uplink transmission includes one or more vibrational output signals, and wherein the control system comprises a distributed vibrational sensing (DVS) system.

16. A method comprising:
generating an uplink transmission from a first downhole tool positioned in a wellbore formed in one or more subsurface formations to a control system positioned at a surface of the wellbore, wherein generating the uplink transmission comprises, encoding, via a transceiver coupled to the first downhole tool, the uplink transmission, and
transmitting, via one or more fiber optic cables, the uplink transmission to the control system, wherein the first downhole tool is wirelessly coupled with the one or more fiber optic cables.

17. The method of claim 16, further comprising:
selectively energizing one or more conductors of a tubing encapsulated conductor (TEC) cable to generate and collapse a magnetic field over time, wherein selectively energizing the one or more conductors encodes a downlink transmission from the control system;
detecting, via a magnetic field detector of the first downhole tool, the magnetic field; and
decoding, via the transceiver, the downlink transmission.

18. The method of claim 16, wherein transmitting the uplink transmission comprises:
applying, via a heating element, a heat to the one or more fiber optic cables, wherein the control system is a distributed temperature sensing (DTS) system.

19. The method of claim 16, wherein transmitting the uplink transmission comprises:
generating, via the first downhole tool, one or more acoustic output signals, wherein the control system comprises a distributed acoustic sensing (DAS) system.

20. The method of claim 16, wherein transmitting the uplink transmission comprises:
generating, via a vibrational element of the first downhole tool, one or more vibrational output signals, wherein the control system comprises a distributed vibrational sensing (DVS) system.
